(19) United States
(12) Patent Application Publication
(10) Pub. No.: US 2015/0201223 A1
(43) Pub. Date: Jul. 16, 2015

(54) PROCESSING, STORING, AND DELIVERING DIGITAL CONTENT

(71) Applicant: InnFlicks Media Group, LLC, Salt Lake City, UT (US)

(72) Inventors: Daniel Osorio, Park City, UT (US); Robert L. Bishop, North Salt Lake, UT (US)

(21) Appl. No.: 14/667,438

(22) Filed: Mar. 24, 2015

Related U.S. Application Data
(63) Continuation-in-part of application No. 14/062,786, filed on Oct. 24, 2013.

(51) Int. Cl. H04N 21/2183; H04N 21/214; H04N 21/222; H04N 21/2543; H04N 21/643; H04N 21/239; H04N 21/2665; H04L 29/06; H04N 21/231

(52) U.S. Cl. CPC H04N 21/2183; H04L 65/4069; H04N 21/2143; H04N 21/2223; H04N 21/23106; H04N 21/64322; H04N 21/2393; H04N 21/2665; H04N 21/2543

(57) ABSTRACT

Implementations of the present invention include a Public Cloud, one or more End-Caches and optionally one or more Edge-Caches in computerized architecture that provides digital content, such as entertainment services and/or informational content, to a guest display (e.g., End-Cache connected to in-room TV, End-Cache connected to personal portable device) or control of one or more devices (e.g., in-room TV and/or in-room control). Implementations of the present invention also include a Content Distribution Architecture that uses the public Internet to securely transmit digital content and data to all desired locations (e.g., End-Caches). Implementations of the present invention further include a Channel Processor that takes one of more video signal(s) and prepares them for redistribution to an end user. Implementations of the present invention leverage existing wiring at the property (whether coax, Ethernet, home-run, or loop-thru) to transport content/data to/from End-Caches.

### CROSS-REFERENCE TO RELATED APPLICATIONS

The present invention is a continuation-in-part of U.S. application Ser. No. 14/062,786, filed on Oct. 24, 2013, entitled “Processing, Storing, and Delivering Digital Content,” which is a continuation of U.S. patent application Ser. No. 13/385,590, filed on Nov. 2, 2010, entitled “Processing, Storing, and Delivering Digital Content.” The entire contents of each of the above applications is incorporated herein by reference in their entireties.

### BACKGROUND

### 1. Background and Relevant Art

The switch to high-definition or “high-def” content has presented a number of challenges for commercial markets, including: the need for new TV channel line-up equipment (high-def capable), the need to encrypt high-def content for security purposes, the need for new TVs (high-def capable), the additional cost of special decryption high-def TVs, the lack of high-def TV channels, the poor quality of std-def analog channels viewed on high-def TVs, the delays in switching TV channels (e.g., between analog and digital TV tuners), the delays in switching TV inputs (e.g., RF, composite, sVideo, component, HDMI), the switch from MPEG-2 to MPEG-4 encoding by content providers (rendering older high-def TVs incompatible), and the high-cost of current, yet incomplete solutions.

For years, video-on-demand or “VOD” movies were considered a necessary amenity for in-room entertainment. The high-def upgrade path for these systems, however, is virtually non-existent (e.g., system components are not upwards-compatible and the entire system is commonly discarded). Rather than purchase new high-def VOD movie systems, many choose to forego VOD movies altogether and install only high-def TV but with premium entertainment channels (e.g., HBO, Showtime). The up-front investment is less costly for these systems but monthly content fees are more expensive (e.g., additional fees assessed for premium channels are per-room, per-month; whether occupied or not). This stands in stark contrast to standard channel fees offset by incremental room revenue of the TV with VOD movies model.

Also, many believe that movies are so easily downloaded or streamed from the Internet (e.g., iTunes, NetFlix) that the need for VOD movie systems is no longer needed; especially given the high-cost for both the equipment (e.g., often double or triple that of a TV system alone) and its content (e.g., which can be double or triple the cost of theater admission and many times more expensive than DVD or Blu-ray rental). Notwithstanding, the bandwidth requirements for streaming movies from the Internet is often not practical, personal portable device screen sizes can suffer as entertainment displays, and personal content has usually been viewed many times (lessoning the desire to view it again).

With the proliferation of personal portable devices (e.g., smart phones, tablets, netbooks, notebooks) and the availability of Internet-based content delivery services, High-Speed Internet Access (“HSIA”) has become as important as the TV. What began, however, as simple access to the Internet for e-mail and web browsing has expanded to include streaming digital content and transferring large files. This presents additional challenges for the commercial market, including: the need for new equipment to properly manage HSIA connections and usage (e.g., bandwidth throttling, tiered services), the need for more/newer wireless equipment to accommodate the number/types of personal portable devices (e.g., traditional and newer wireless frequency ranges), the cost of additional Internet bandwidth, and the need for expanded HSIA services (e.g., captive portal, network monitoring, help desk).

Remotely managing in-room controls (e.g., temperature, lighting, curtains) in guest rooms that are unoccupied and/or during certain times of the day can significantly save energy costs. Manufacturers and vendors of in-room controls, however, are often forced to duplicate existing infrastructure (e.g., wireless network) to manage these devices; thereby creating additional cost and possible interference.

### BRIEF SUMMARY

Implementations of the present invention include one or more systems, methods, processes, and computer program products configured to provide a high-featured yet inexpensive in-room entertainment, information, and control system (which can include TV channels, VOD movies, other video sources, HSIA, in-room controls, and other guest services) that is more affordable for owners and their guests; overcoming major obstacles in the switch to high-def content, addressing the expanded requirements of personal portable devices, and managing in-room controls.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a schematic view that illustrates the manner in which various system components can interact with each other and other devices;

FIG. 2 is a schematic view that illustrates the manner in which the Private Cloud can be connected to the Public Cloud;

FIG. 3 is a schematic view that illustrates Application Module(s) in a Public Cloud cached through a private network to Edge-Caches in the Private Cloud;

FIG. 4 is a schematic view that illustrates the manner in which the End-Cache interacts with Application Module(s) (whether at the Edge-Cache or the Public Cloud) as well as input and output devices;

FIG. 5 is a schematic view that illustrates the manner in which a device is connected to the back of a Hospitality TV for program control;

FIG. 6 is a schematic view that illustrates the manner in which Hospitality TV APIs can be abstracted into a general purpose “TV API,” allowing applications to operate independent of a given Hospitality TV and its corresponding API;

FIG. 7 is a schematic view that illustrates the manner in which Edge-Caches in the Private Cloud can be securely connected to the Public Cloud utilizing a “Mesh” VPN;

FIG. 8 is a schematic view that illustrates how multicast traffic can be encrypted and encapsulated so that it passes undisturbed through standard network transport layers of the public Internet;

FIG. 9 is a schematic view that illustrates a content distribution file;

FIG. 10 is a schematic view that illustrates content distribution from Application Module(s) in the Public Cloud to corresponding EdgeCache(s);

FIG. 11 is a schematic view that illustrates the CP including its inputs and output;

FIG. 12 is a schematic view that illustrates the manner in which a TV signal travels from its source to the End-Cache;

FIG. 13 is a schematic view that illustrates the manner in which channels are mapped;

FIG. 14 is a schematic view that illustrates the main user interface elements displayed by the End-Cache;

FIG. 15 is a schematic view that illustrates a DVD player remote control;

FIG. 16 is a schematic view that illustrates vertical navigation; and

FIG. 17 is a schematic view that illustrates horizontal navigation.

### DETAILED DESCRIPTION

Implementations of the present invention include an architecture comprising a Public Cloud, one or more End-Caches, and optionally one or more Edge-Caches. In this architecture, an application and its functionality (i.e., Application module(s) and their corresponding data) live in the cloud (i.e., Public Cloud); are cached where they are currently physically needed (i.e., Edge-Cache); and provide digital content, such as entertainment services, and/or informational content, to a guest display or device (e.g., End-Cache connected to in-room TV, End-Cache connected to personal portable device, End-Cache connected to in-room control). In addition, the system architecture anticipates eventual resolution of the current speed/bandwidth versus cost barrier to the public Internet (for high-bandwidth content), thereby possibly removing the need for a local cache.

Implementations of the present invention also include a Content Distribution Architecture. In this architecture, an application and its functionality (i.e., Application Module(s) and their corresponding data) in the cloud (i.e., Public Cloud) use the public Internet to securely broadcast large digital media file(s) to all desired locations (e.g., Edge-Caches). In addition, complex content distribution is more easily managed through distribution file attributes that can include: property type, language, culture, geographic location, and defined group.

Implementations of the present invention further include a Channel Processor (“CP”). In general, the CP takes one or more video signals from one or more video sources, decrypts the signal (if encrypted), processes the signal for redistribution (e.g., transcoding/encoding the video, audio, and close caption or subtitle streams to the desired format(s)), and encrypts the signal. The resulting signal/channel is streamed to the End-Cache when requested. Accordingly, the CP overcomes the need for special decryption TVs or TVs with MPEG-4 decoding capability and makes moot previous delays in switching TV channels (e.g., between analog and digital TV tuners).

Implementations of the present invention can leverage existing wiring at the property (whether coax, Ethernet, home-run, or loop-thru) to transport content/data to/from End-Caches.

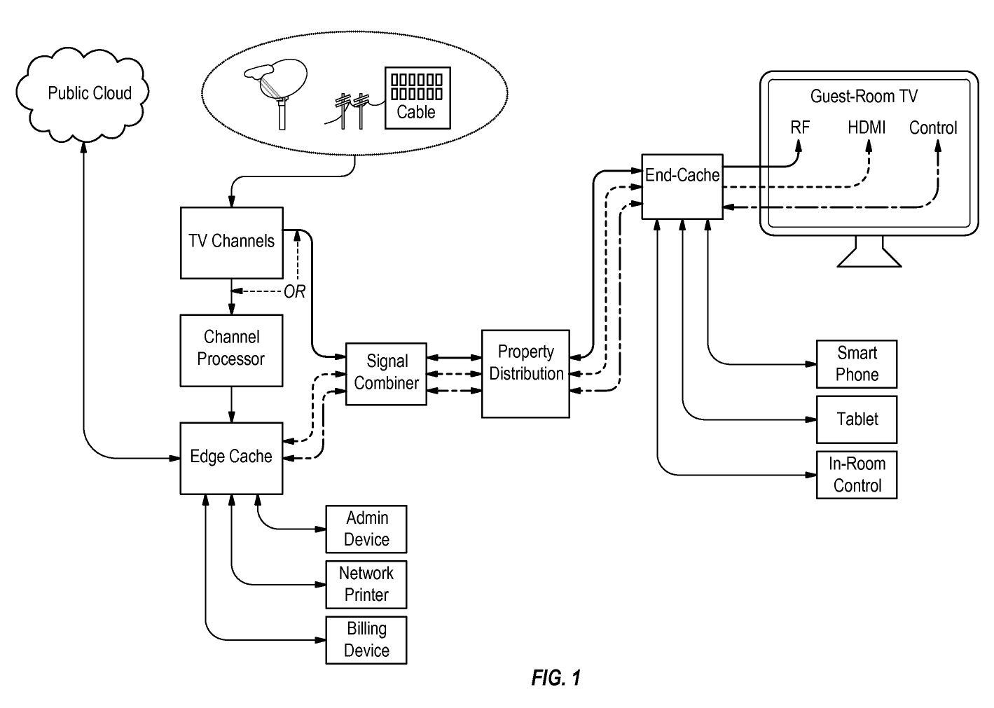

FIG. 1 is a schematic view that illustrates the manner in which various system components can interact with each other and other devices.

### Public Cloud

The “Public Cloud” consists of computing and data resources connected to the public Internet offered on-demand by one or more independent service providers (e.g., Amazon, Gogrid, Rackspace).

### Application Modules

In the illustrated embodiment, the computer program(s) or computer code or any other functionality of the present invention comprise one or more Application Modules that supply the overall functionality of the system (e.g., management, reporting, billing, monitoring, asset management, device management, customer management, guest management, content management and serving, channel management and serving, concierge management and serving, EPG management and serving, advertising management and serving, HSIA management, and GUI management are examples of potential Application Modules). Each instance (i.e., computing and data resources expressed in virtualized hardware resources in the Public Cloud) of an Application Module contains the program logic and associated data for that particular module.

### Private Cloud

In the illustrated embodiment, the “Private Cloud” includes computing and data resources connected to the public Internet (but not accessible by the public) and one or more private networks. The Private Cloud contains two types of computing and data resources (i.e., an edge-cloud cache node or “Edge-Cache” and an end-cloud cache node or “End-Cache”).

In the illustrated embodiment, the Edge-Cache contains a copy of each Application Module in the Public Cloud, including its program logic and the data that corresponds (or is relevant) to the geographic location of the End-Cache(s) connected to it. The physical location of an Edge-Cache can be determined by the speed and reliability of the network used to communicate with its End-Cache(s) as well as its physical security. Although the Edge-Cache is usually connected to a local-area network of End-Cache(s), it can be connected to any network (e.g., wide-area network) or network topology (e.g., fiber, cable) of End-Cache(s) as long as speed, reliability, and security are not decidedly compromised. The Edge-Cache can help solve the practical limitations of cost versus speed for bandwidth to the public Internet. When speed requirements become less cost prohibitive, the Edge-Cache may no longer be needed and the End-Cache(s) will communicate directly with the Public Cloud. While cost remains a factor in some applications, the Edge-Cache can provide desired system functionality operability and at reduced costs.

In the illustrated embodiment, an End-Cache can contain computing and data resources to deliver content to a guest display or device (e.g., in-room TV, personal portable device, in-room control) and receive input from its operator. It is typically positioned in close proximity to the display (e.g., inside the display as an integral part thereof, attached to the back of the display, attached to a piece of furniture on which the display rests) but preferably out of operator view. The End-Cache can receive operator input via input device(s) (e.g., remote control, keyboard, mouse), navigate system menus, perform or relay transactions (e.g., order movie, guest check-out), control in-room devices (e.g., TV, temperature), provide HSIA connections to personal portable devices (e.g., smart phone, tablet, netbook, notebook) and render content, including: movies (e.g., hosted, provider-hosted, third-party hosted), television programming (e.g., over-the-air, cable, satellite), information (e.g., amenities, restaurants, shopping), and the like.

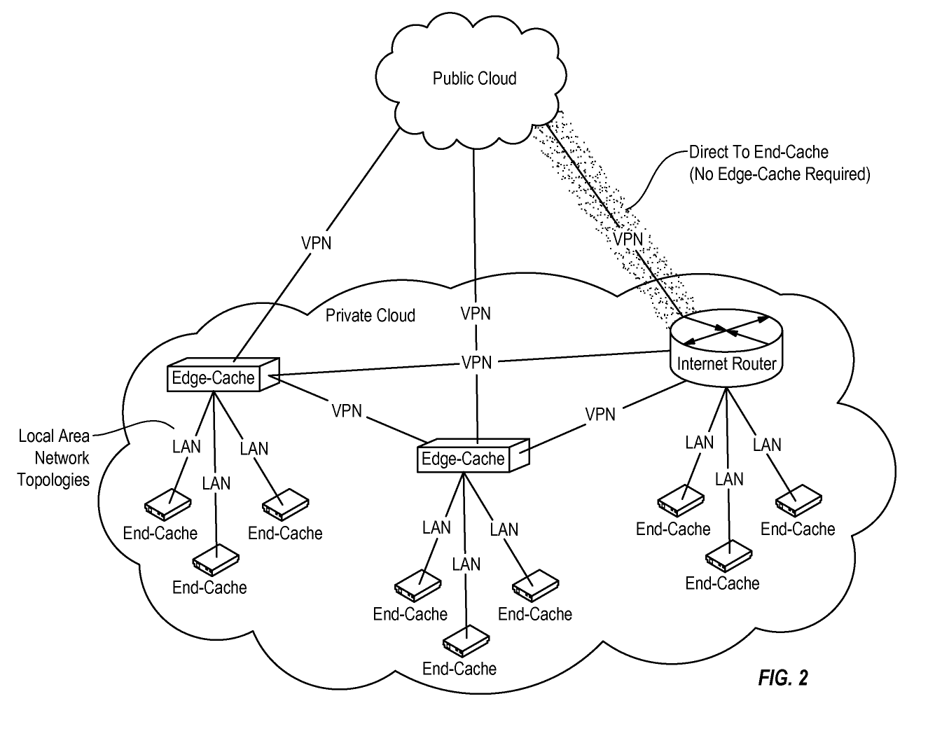

FIG. 2 is a schematic view that illustrates the manner in which the Private Cloud can be connected to the Public Cloud. In the illustrated embodiment, a private network connects three End-Caches (with no corresponding Edge-Cache) and two Edge-Caches to the Public Cloud (and to each other). The illustration also demonstrates three End-Caches connected to each Edge-Cache through a local network.

### Edge-Cache

In the illustrated embodiment, the Edge-Cache can comprise off-the-shelf hardware (e.g., industrial-quality components with preferably very small failure rates) and software, including a cache (or copy) of instances of Application Modules in the Public Cloud used by its corresponding End-Caches (i.e., those End-Caches with adequate connection speeds). Each Edge-Cache relays data (e.g., transactions, HSIA traffic) between its End-Caches and Application Modules in the Public Cloud and caches content (e.g., movies, advertisements) for display by its End-Caches.

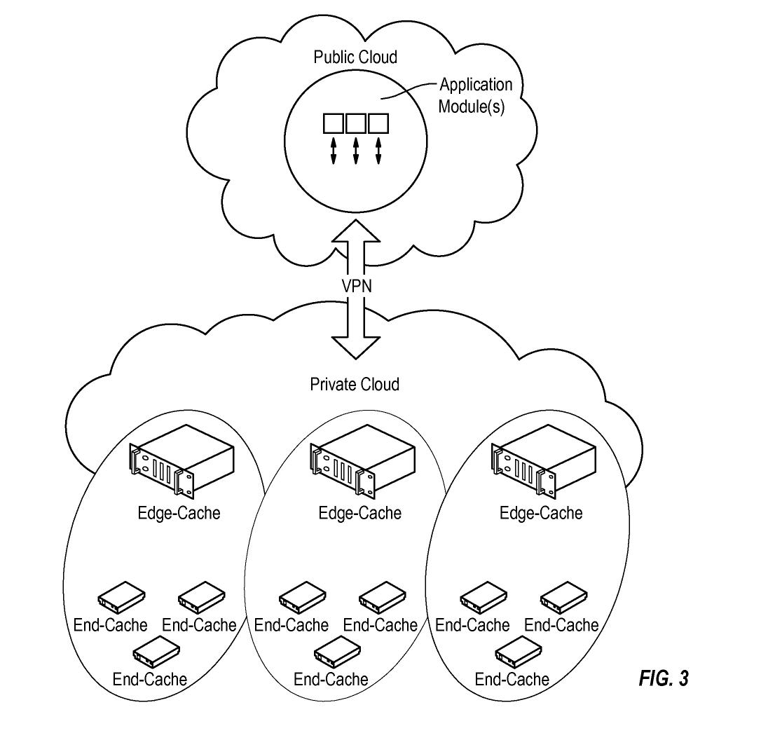

FIG. 3 is a schematic view that illustrates Application Module(s) in a Public Cloud cached through a private network to Edge-Caches in the Private Cloud.

### End-Cache

In the illustrated embodiment, the End-Cache can comprise proprietary hardware and software, including Application Modules.

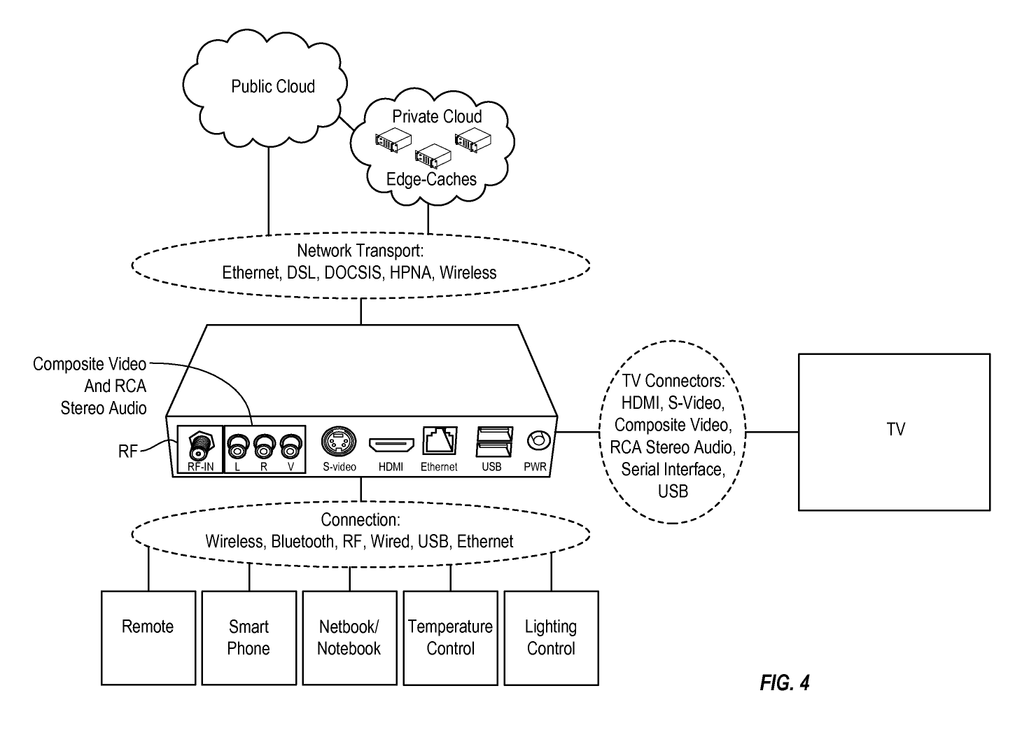

FIG. 4 is a schematic view that illustrates the manner in which the End-Cache interacts with Application Module(s) (whether at the Edge-Cache or the Public Cloud) as well as input and output devices. In the illustrated embodiment, hardware inputs can include local devices (i.e., one-to-one such as a remote, keyboard, mouse, etc.) via standard connections (e.g., infrared, RF, Bluetooth, wireless, cables) and network devices (i.e., several-to-several such as Edge-Caches, printers, etc.) via standard connections (e.g., Ethernet, DSL, wireless). Hardware outputs can include analog and digital video signals (e.g., RF, composite, sVideo, HDMI) for both standard-definition and high-definition content, TV control (e.g., input, channel, volume), other device control (e.g., temperature, lighting), and communication with Application Modules (whether at the End-Cache or Public Cloud).

Each End-Cache is connected to viable Edge-Cache(s) (or directly to the Public Cloud if none). It displays and allows the system operator to navigate through system menus and perform various functions (e.g., watch TV, order a movie, print a local restaurant choice, etc.). The TV channel lineup can originate from whatever source (e.g., cable providers like Comcast or Cox and satellite providers like DirecTV or Dish Network or future channel line-up providers via the Internet). Because of its importance, the End-Cache carefully monitors TV service accessibility. When the End-Cache is notified that a particular TV channel is temporarily unavailable (e.g., hardware failure, service outage), the channel is removed from the channel lineup until the End-Cache is notified that the channel is available again.

The licensed content delivered to the End-Cache (e.g., movies, TV channels, HSIA traffic) can be secured using industry-standard encryption mechanisms (i.e., AES-256 bit—the same encryption required by the US Government for highly-sensitive data). Content (whether analog, digital, standard-definition, high-definition) delivered from the End-Cache to the guest display (e.g., in-room TV) is secured using industry-standard encryption mechanisms (i.e., Macrovision for composite and sVideo outputs and HDCP for HDMI output—no unencrypted signals like with component outputs are included).

### Display Control

Each hospitality-grade TV or “Hospitality TV” manufacturer supplies a communications port in the back of the unit and corresponding API to allow program control of the TV.

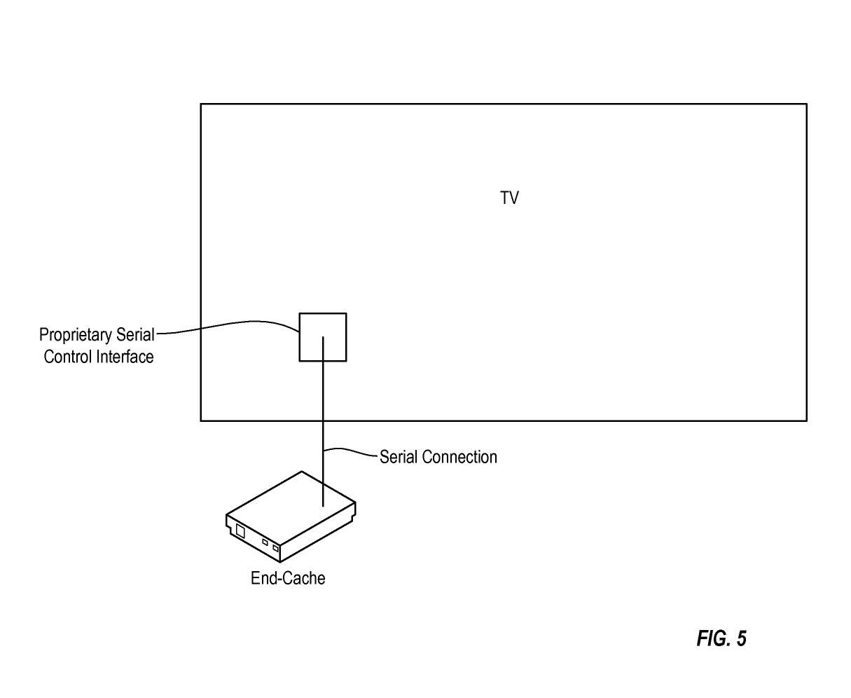

FIG. 5 is a schematic view that illustrates the manner in which a device is connected to the back of a Hospitality TV for program control. In the illustrated embodiment, the physical connection to an End-Cache is made through a proprietary serial control interface. Although each Hospitality TV API is specific to a given TV, Hospitality TV APIs themselves offer similar functionality and operate in a similar fashion.

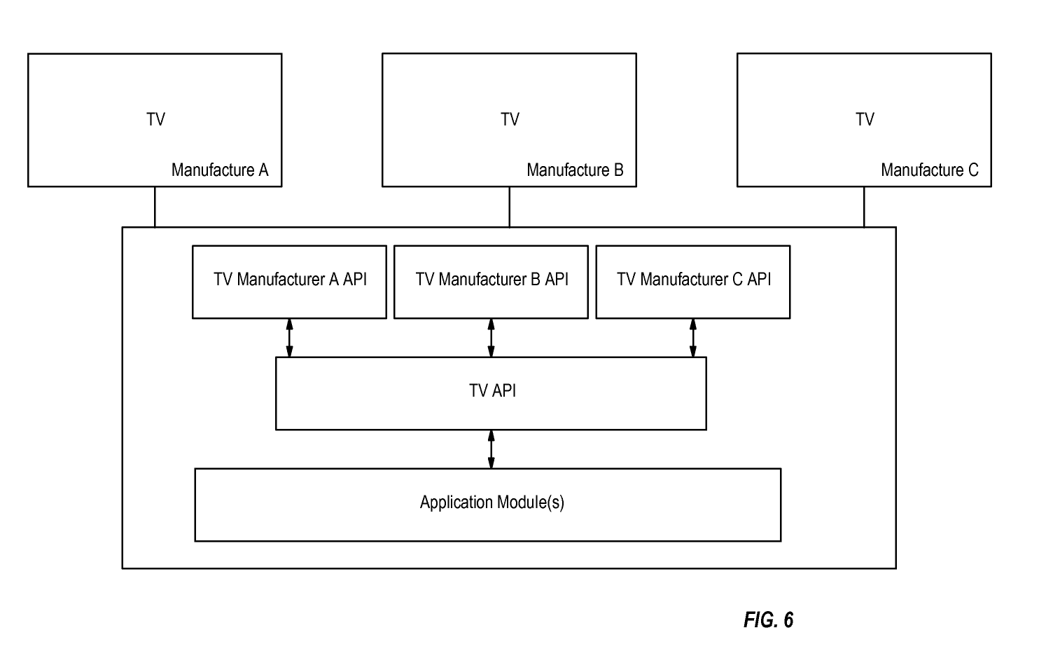

FIG. 6 is a schematic view that illustrates the manner in which Hospitality TV APIs can be abstracted into a general purpose “TV API,” allowing applications to operate independent of a given Hospitality TV and its corresponding API.

In the illustrated embodiment, an application interacts with a single TV API to control operation of dissimilar TVs, including Manufacturer A, Manufacturer B, and Manufacturer C. This can be done by mapping the functional equivalent of each TV API call to its specific implementation using the given Hospitality TV API. In this way, supporting an additional Hospitality TV becomes the simple task of mapping the TV API to the new Hospitality TV API rather than the task of re-writing or reworking a large base of application program source code. The End-Cache uses the TV API to control, among other things, the TV input (e.g., new vs. legacy signal), channel (e.g., up, down, previous), volume (e.g., up, down, mute), and the like.

In the illustrated embodiment, this layer of hardware abstraction can be performed for other devices (e.g., temperature and lighting controls).

### Content Distribution

As previously stated, the Edge-Cache helps solve the practical limitations of cost versus speed for bandwidth to the public Internet. Thus, high-bandwidth files (e.g., movies and the like), are cached where they can be accessed with local-area network speeds (as opposed to slower and more-costly Internet connection speeds). These high-bandwidth files are uniquely and securely distributed from Application Module(s) in the Public Cloud to Edge-Caches in the Private Cloud.

Distributing digital media files (which can be quite large) to multiple locations has historically presented a problem (both in time and in cost). Some send copies on physical media (e.g., disc drives) to each location; while others use satellites to broadcast the data. In comparison, the public Internet represents a possible low-cost mechanism for distributing digital media files.

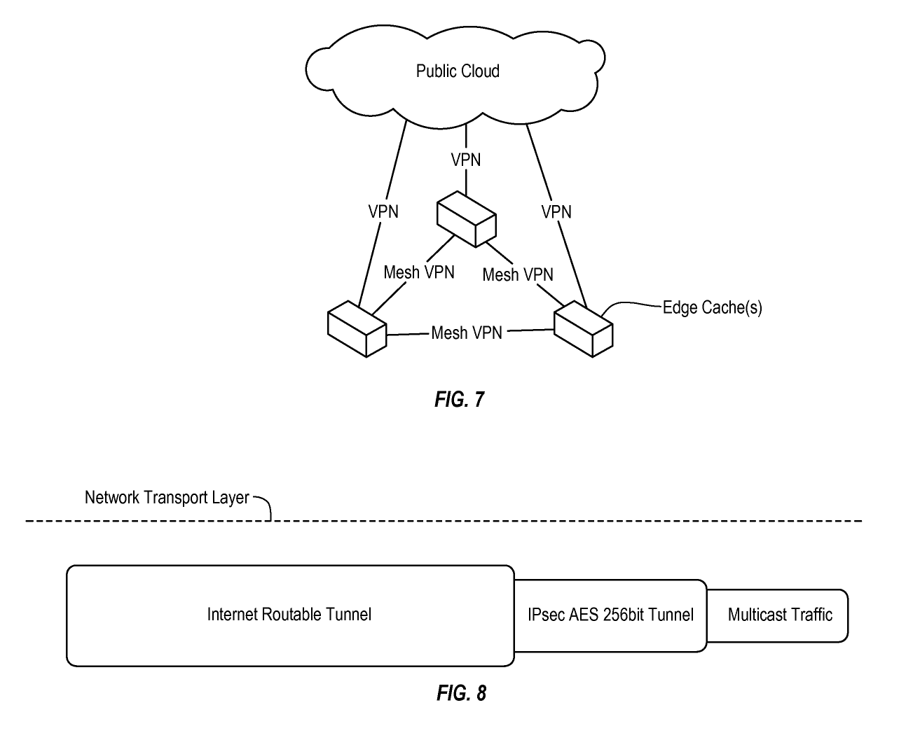

FIG. 7 is a schematic view that illustrates the manner in which Edge-Caches in the Private Cloud can be securely connected to the Public Cloud utilizing a “Mesh” VPN. In the illustrated embodiment, Application Modules can not only securely communicate with each Edge-Cache, but each Edge-Cache can also securely communicate with other Edge-Cache(s) when authorized to do so. File transfer is accomplished via tunnels (each a one-to-one connection between an Application Module in the Public Cloud and a desired Edge-Cache).

FIG. 8 is a schematic view that illustrates how content/data can be encrypted and encapsulated so that it passes undisturbed through standard network transport layers of the public Internet.

### Content Management

A particular piece of content can be made up of many files. For example, a single movie may consist of the movie file, movie trailer file, movie art file, and movie information file. To reduce complexity and file size(s), all files that correspond to a given piece of content are grouped together and compressed (using industry-standard compression) into a single distribution file.

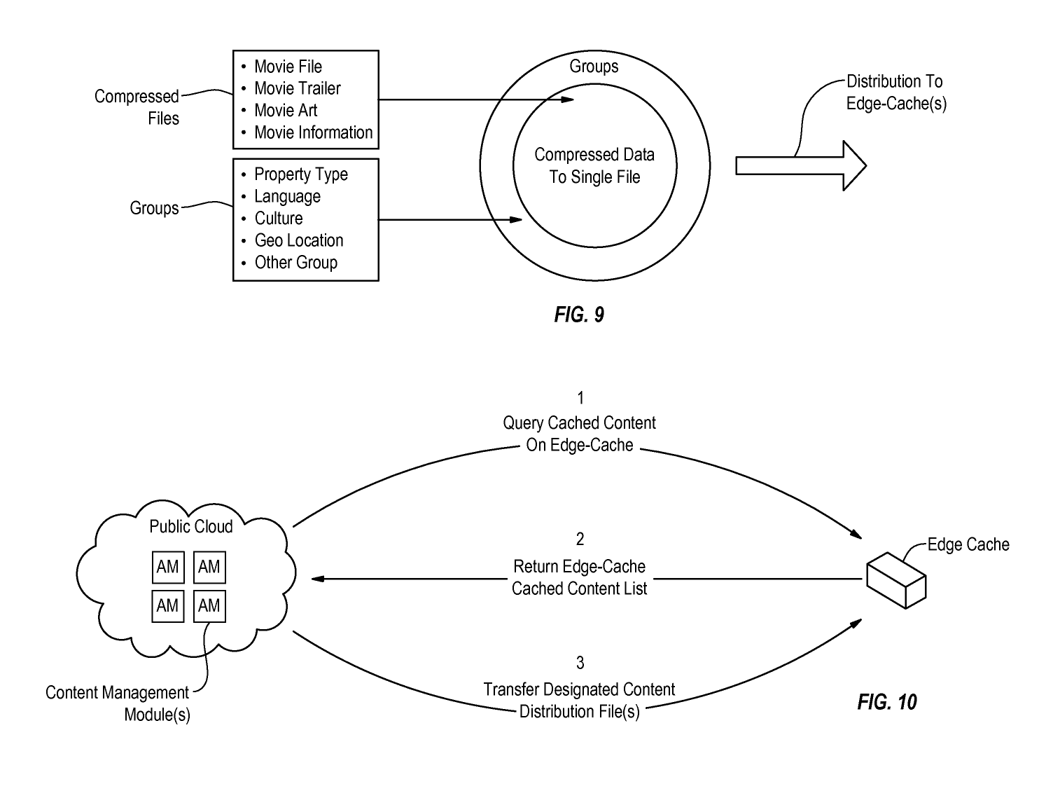

FIG. 9 is a schematic view that illustrates a content distribution file. In the illustrated embodiment, the compressed distribution file (which includes the movie, trailer, art, and information) is also associated with group attributes (e.g., property type, language, culture, geographic location). The “Content Manager” is an Application Module that orchestrates the secure transfer of content distribution file(s) from the Public Cloud to corresponding Edge-Caches. Each Edge-Cache is queried to find out what content it currently has cached. This information is then compared to the content the Edge-Cache should have (based on factors, including its group attributes). The Content Manager then creates a distribution list for each piece of content and corresponding Edge-Caches that need that content.

Once the distribution list(s) are complete, the Content Manager transfers each distribution file by establishing a tunnel connection with all Edge-Caches that require the content file and then distributing the file as explained above. FIG. 10 is a schematic view that illustrates content distribution from Application Module(s) in the Public Cloud to corresponding EdgeCache(s). In the illustrated embodiment, a query is performed, a response is received, a distribution list is created, and a file is sent. This allows all distribution files to be received by their corresponding Edge-Caches.

### Channel Processor

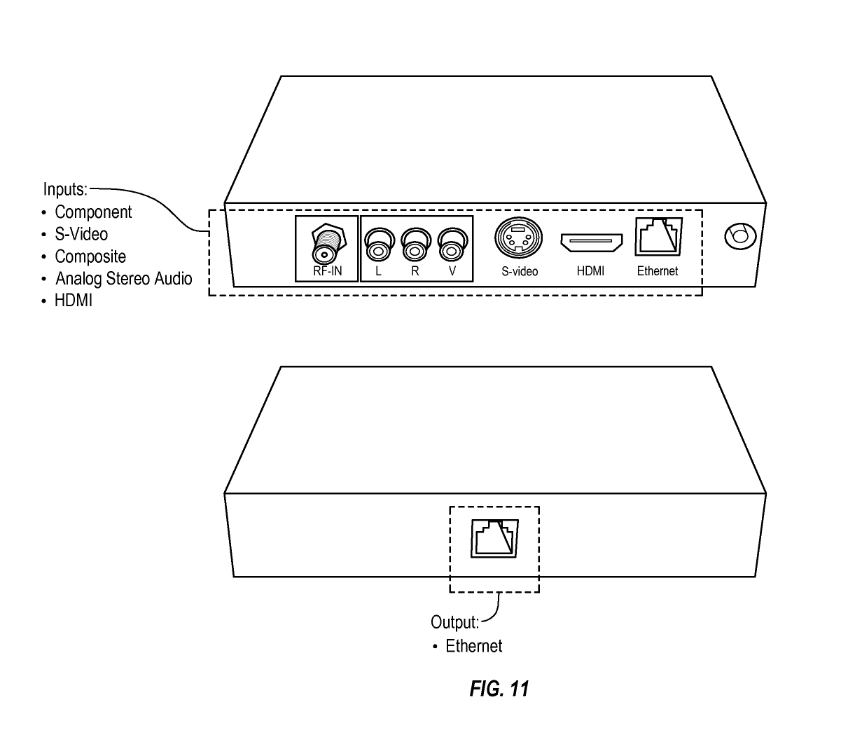

The Channel Processor or “CP” consists of proprietary hardware and software. FIG. 11 is a schematic view that illustrates the CP including its inputs and output. In the illustrated embodiment, the inputs are RF, composite, sVideo, component, Ethernet, and HDMI and the output is Ethernet. Hardware inputs can receive either analog or digital video signals (e.g., std-def or high-def content) but only one signal can be processed at a time. According to one embodiment of the present invention, the CP performs the following functions in real-time:
if the video signal content is encrypted, the content is decrypted;
the video signal is then processed, including: transcoding/encoding the video, audio, and close caption streams to the desired format(s) (e.g., MPEG-4 AVC/H.264).
the video signal is then encrypted using AES-256 bit encryption; and
the video signal is output through the Ethernet port to the Channel Server at the Edge-Cache.

The CP can process any standard video signal whether from local devices (e.g., output from a cable box, satellite receiver, Blu-ray player, DVD player, AppleTV media player, Roku media player), portable devices (e.g., smart phones, tablets, netbooks, notebooks) connected via wireless display protocols (e.g., AirPlay, Chromecast, Miracast, DLNA, WiDi), and streaming video services over the Internet (e.g., Netflix, Hulu, YouTube).

The CP is a network device and can be configured remotely. If no video signal is present, the CP sends a message to the Channel Server alerting the situation.

### Channel Delivery

Once at the Channel Server, the video signal is briefly delayed for closed caption or subtitle syncing and then secured using AES-256 bit encryption before it is transmitted to the End-Cache(s). If closed captioning or subtitling is desired, the closed caption or subtitle text sent from the CP can be transmitted along with the encrypted video signal and displayed by the End-Cache(s).

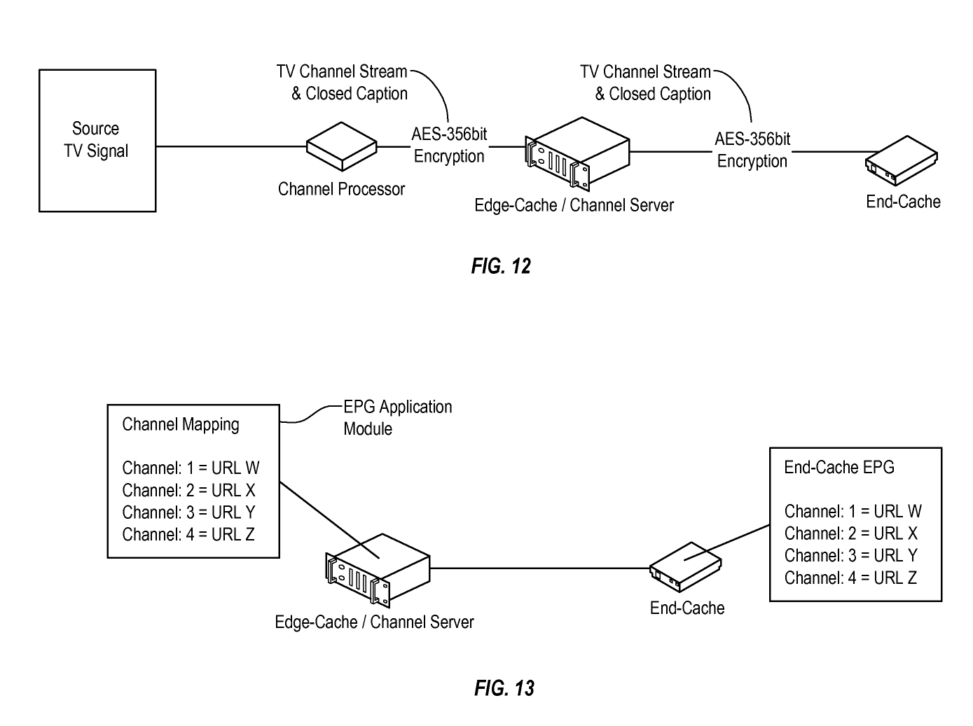

FIG. 12 is a schematic view that illustrates the manner in which a TV signal travels from its source to the End-Cache. In the illustrated embodiment, the source signal first travels to the Channel Processor, then to the Edge-Cache/Channel Server, and finally to the End-Cache.

In the illustrated embodiment, each real-time content signal (e.g., TV channel, welcome message) is broadcast from a specific URL at the Edge-Cache. Channel mappings are maintained by the EPG Application Module and viewing a specific channel is performed by simply connecting the End-Cache to the URL at the Edge-Cache that corresponds to that particular channel.

FIG. 13 is a schematic view that illustrates the manner in which channels are mapped. In the illustrated embodiment, the EPG Application Module maintains channel mappings that are communicated to the End-Cache EPG, including Channel 1 found at URL W, Channel 2 found at URL X, Channel 3 found at URL Y, and Channel 4 found at URL Z. The EPG also provides a mechanism for inserting VOD movies into the channel guide for immediate purchase and viewing. This method (also used by cable and satellite TV providers) may be familiar to many and provides a mechanism for cross-selling VOD movies.

Another feature allows current program information to be overlayed on the screen while a TV channel is being viewed. In this channel overlay mode, channel information can be cycled from channel-to-channel and a new channel can be selected at any time.

Other information, including system-wide messages (e.g., safety alert), specific group messages (e.g., event time or location change), and individual messages (e.g., welcome message) can be overlayed on the screen while the TV is being viewed.

### User Interface

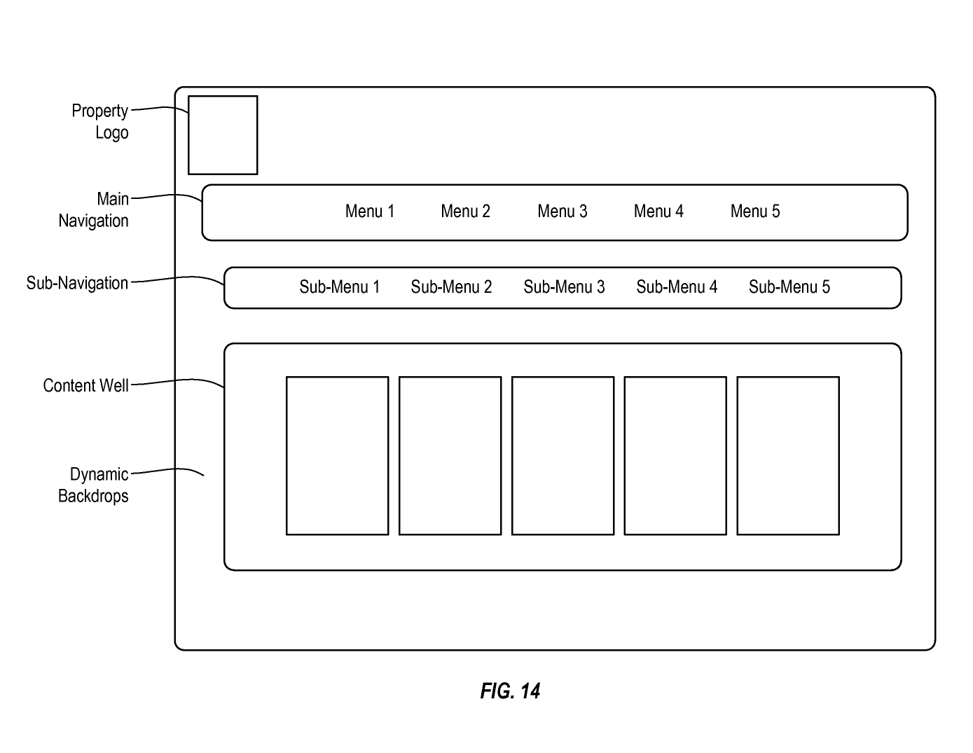

FIG. 14 is a schematic view that illustrates the main user interface elements displayed by the End-Cache. In the illustrated embodiment, the display is composed of a property logo, main-navigation menu, sub-navigation menu, and content well that appear to float on dynamic backdrops (i.e., images, video, or other digital content).

Consistency in user interaction can be helpful to new operators of the system (i.e., the operator intuitively knows what to do without thinking about it). System menus can be navigated using standard DVD player buttons (i.e., up, down, right, left, and select).

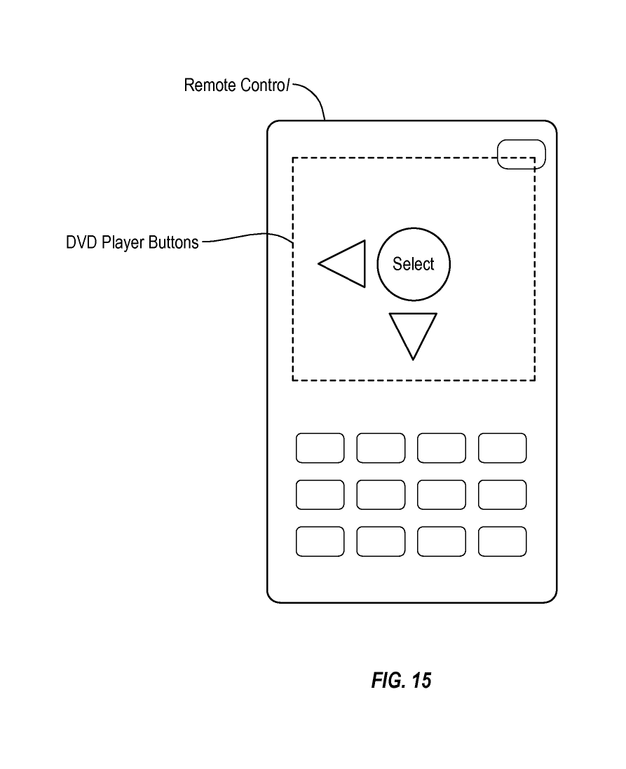

FIG. 15 is a schematic view that illustrates a DVD player remote control. In the illustrated embodiment, the standard DVD player buttons are highlighted. These buttons are also found on most audio/video remote control and their operation will tend to be familiar to most operators. When the up and down arrows are pressed, the highlight selection moves up and down the screen (centered horizontally) but doesn't move right or left (except inside the EPG grid; familiar to almost everyone).

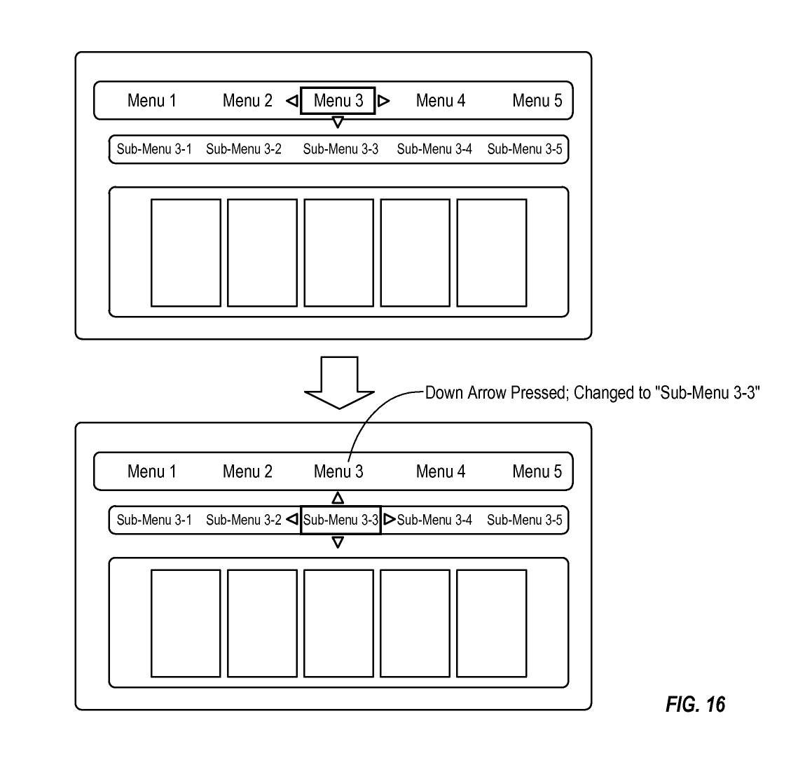

FIG. 16 is a schematic view that illustrates vertical navigation. In the illustrated embodiment, when the down arrow is pressed, the highlight moves from the currently selected main menu item to the corresponding sub-menu item. Instead, when the right or left arrow is pressed, the menu options themselves scroll to the center (rotating like a big wheel) left or right respectively.

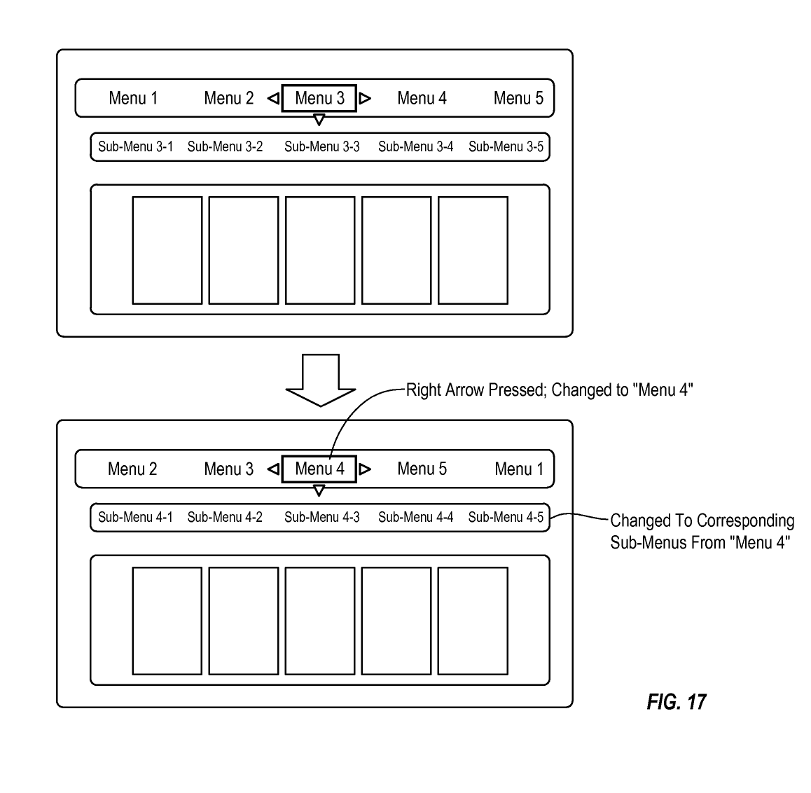

FIG. 17 is a schematic view that illustrates horizontal navigation. In the illustrated embodiment, when the right arrow is pressed, all menu items scroll left and the sub-menu that corresponds to the newly highlighted menu item is displayed below. As the highlight selection moves top to bottom, menu choices become more specific. For example, main menu options may be displayed horizontally at the top. Sub-menu options that correspond to the currently highlighted menu option may be displayed below. When select or down is pressed, the highlight moves to the sub-menu below and sub-sub menu options that correspond to the then currently highlighted sub-menu option are displayed below, and so on (until the bottom menu). The select button always performs just that (i.e., selects the highlighted option).

Menus options are dynamic (i.e., content driven) and display only if there is corresponding content. For example, if a particular channel is not broadcasting, the channel is removed from the channel guide until it returns. If there are no western genre movies, “western” will not appear as an available movie genre. If a special promotion expires, it no longer appears as an option. No changes are needed to the menu (or user interface) system.

According to one illustrative embodiment of the present invention auto-branding to the property can be accomplished through dynamic backdrops (e.g., menus float on images of the property). Also, closer content relationships with incremental revenue opportunities can be forged by auto-stitching current relevant movie trailer(s) at the start of a VOD movie and offering DVD or Blu-ray purchase at the end (fulfilled through third-party relationships such as iTunes, Amazon.com, and like).

### Digital Concierge

Local information (e.g., amenities, restaurants, shopping, attractions) can be monetized through paid inclusion in the “Concierge Application Module” which makes the information available on each guest display (i.e., in-room TV). Operators can select their desired choice(s) for printing (usually output to a network printer or smart phone). The output provides information for the chosen selection which may include: establishment name, hours of operation, physical address, telephone number, travel directions, promotional coupons, and the like. Since guests represent highly targeted leads (i.e., a nearby captive audience), establishments (i.e., potential advertisers) may find it a worthwhile choice when deciding where to allocate their advertising budget.

### Computer Storage Media

The embodiments of the present invention may comprise a special purpose or general-purpose computer including various computer hardware, as discussed in greater detail below. Embodiments within the scope of the present invention also include computer-readable media, including computer-readable storage media, for carrying or having computer-executable instructions or data structures stored thereon. Such computer-readable media can be any available media that can be accessed by a general purpose or special purpose computer.

By way of example, and not limitation, such computer-readable media, or computer-readable storage media, can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A computerized system that provides delivery of multimedia data to an end-user by utilizing various network communication protocols, the system comprising:
a channel processing module, wherein the channel processing module receives one or more signals encoded in a first format and converts the one or more signals into a second format;
an edge-cache module in communication with the channel processing module through a network connection, wherein the edge-cache module receives data transmitted from one or more external sources, including the channel processing module; and
a plurality of end-cache modules in communication with the edge-cache module, wherein:
the plurality of end-cache modules are disposed within the same local network as the edge-cache module,
the plurality of end-cache modules are configured to access cached and streamed information from the edge-cache module, and
the plurality of end-cache modules are configured to output data directly to a corresponding plurality of television displays.

2. The system as recited in claim 1, wherein at least one of the plurality of respective television displays is not compatible with the first format.

3. The system as recited in claim 1, wherein the edge-cache module comprises a billing functionality.

4. The system as recited in claim 1, wherein the edge-cache module is in communication with at least one of the plurality of end-cache modules through a coaxial cable infrastructure.

5. The system as recited in claim 4, wherein at least a portion of the data transmitted through the coaxial cable infrastructure by the edge-cache module comprises a plurality of television channels.

6. The system as recited in claim 5, wherein at least a portion of the television channels are independently mapped to unique uniform resource locators such that the plurality of end cache modules can independently access different television channels by requesting access to a particular unique uniform resource locator.

7. The system as recited in claim 4, wherein at least a portion of the data transmitted through the coaxial cable infrastructure by the edge-cache module comprises a plurality of Over-The-Top (OTT) content.

8. The system as recited in claim 7, wherein at least a portion of the Over-The-Top (OTT) content is independently mapped to unique uniform resource locators such that the plurality of end cache modules can independently access different Over-The-Top (OTT) content by requesting access to a particular unique uniform resource locator.

9. The system as recited in claim 4, wherein the edge-cache module also serves as an internet gateway for user devices connected to one of the plurality of end-cache modules.

10. The system as recited in claim 9, wherein the user device streams content through an end-cache module to a television display that is connected to the end-cache module.

11. The system as recited in claim 9, wherein the end-cache module streams content to the user device.

12. At an edge cache module in a computerized system that provides local management of a multimedia system through the edge-cache module, wherein the edge-cache module is configured to provide content received from one or more external sources to a display device, a computerized method comprising:
receiving data at the edge cache module from a plurality of different data sources, wherein the received data comprises a variety of different data formats;
in response to a received query from an external source sending one or more signals to the external source that identify at least a portion of the data that is currently cached within the edge-cache module;
receiving a data stream from the external source, the data stream containing additional data to cache at the edge-cache module;
mapping one or more distinct segments of the received data to one or more unique uniform resource locators;
receiving a request from a user within the same local network as the edge-cache module to access data provided at one of the unique uniform resource locators; and
providing the user access to the data provided at the unique uniform resource locator.

13. The method as recited in claim 12, wherein data received from at least one of the plurality of different data sources comprises live television channels.

14. The method as recited in claim 12, wherein data received from at least one of the plurality of different data sources comprises Over-The-Top (OTT) content.

15. The method as recited in claim 12, wherein the edge-cache module is in communication with a user device through a coaxial cable infrastructure.

16. The method as recited in claim 12, wherein the data stream comprises video files to be cached at the edge-cache module.

17. The method as recited in claim 16, wherein the end-cache module streams content to the end-user device.

18. The method as recited in claim 12, wherein the user device streams content through an end-cache module to a television display that is connected to the end-cache module.

19. The method as recited in claim 12, further comprising:
receiving, at the edge-cache module, a request to print a document, wherein the request to print the document originated from an end-user located on the same local network as the edge-cache module; and
communicating the request from the edge-cache module to a network printer.

20. A content and control system for delivering multimedia data and control data to various locations where the video distribution is shared using an existing wire infrastructure, the system comprising:
a media server disposed within a local network, wherein:
the media server receives information through a plurality of different interface mediums from external data providers and caches at least a portion of the received information, and
the media server comprises one or more control modules that allow an administrator on the local network to access and control the media server;
multiple end-user modules disposed within the local network and in communication with the media server through the local network, wherein:
at least a portion of the local network connects the media server with one or more of the multiple end-user modules,
the multiple end-user modules are in direct communication with a television set and are configured to provide multimedia content viewable through the television set, and
the multiple end-user modules comprise wireless antennas configured to communicate with third-party devices.

21. The system as recited in claim 20, wherein the at least the portion of the local network that connects the media server with one or more of the multiple end-user modules comprises coaxial cable.

22. The system as recited in claim 20, wherein the cached at least a portion of the received information comprises video content.

23. The system as recited in claim 21, wherein the video content is accessible by at least one of the multiple end-user modules.

24. The system as recited in claim 20, wherein the media server comprises a configurable digital concierge that is accessible by the multiple end-user modules.

25. In a network comprising an edge cache and a plurality of end caches, a method for streaming video content over a network from the edge cache to any of the end caches, the method comprising:
receiving, by the edge cache, a request for video content from a first end cache of a plurality of end caches connected to the edge cache;
accessing, by the edge cache, a local cache to obtain the requested video content;
creating, by the edge cache, a stream of IP data packets containing the video content;
encrypting, by the edge cache, the IP data packets using one or more encryption algorithms;
transmitting, by the edge cache, the encrypted stream to a cable distribution component; and
transmitting, by the cable distribution component, the encrypted stream over the network.

26. The system as recited in claim 25, further comprising encrypting, by the cable distribution component, the encrypted stream with at least one encryption algorithm.

27. The method of claim 25, wherein each of the plurality of end caches is associated with a different TV.

28. The method of claim 25, wherein the request for video content is received in response to a guest requesting to view the video content on a television connected to the end cache.

29. The method of claim 25, further comprising:
transmitting a control command via the edge cache over the network to one of the plurality of end caches, wherein the control command is directed to a device connected to the end cache, wherein the control command controls a function of the device.

30. The method of claim 29, wherein the device connected to the end cache comprises one of: a television, a cable or satellite receiver, a light fixture, an HVAC device, or curtains.

31. The method of claim 25, further comprising:
receiving, by the edge cache, video content from a cloud, wherein the video content is distributed within one or more distribution files.

32. The method of claim 31, wherein each of the one or more distribution files contains a single title of the video content, and wherein each distribution file contains one or more group attributes associated with the title within the distribution file.

33. The method of claim 32, wherein the one or more group attributes comprise one or more of:
one or more property types, one or more languages, one or more cultures, one or more geographic locations, one or more promotions, one or more advertisements, or one or more demographic attributes that the corresponding title is associated with; and
wherein each distribution file received by the edge cache includes one or more group attributes that match one or more attributes of a location where the edge cache is located or one or more attributes of a user using an end cache in the location.

34. In a network comprising a plurality of end caches connected to a network, a method for streaming video content over the network to any of the end caches via a cable distribution component, the method comprising:
receiving, at a computer system within a cloud of computer systems, a request for video content from a first end cache of a plurality of end caches connected to the edge cache over the network via a cable distribution component;
obtaining, from the cloud, the requested video content;
creating, within the cloud, a stream of IP data packets containing the video content;
encrypting, within the cloud, the IP data packets using one or more encryption algorithm;
transmitting, from the cloud, the encrypted stream to a cable distribution component connected to the network; and
transmitting, by the cable distribution component, the encrypted stream over the network.

35. The system as recited in claim 25, further comprising encrypting, by the cable distribution component, the encrypted stream with at least one encryption algorithm.

36. The method of claim 34, further comprising:
prior to receiving the request for video content, receiving a request to view available video content from the first end cache;
determining which video content is to be made available for selection at the first end cache, wherein the determination is based on one or more group attributes associated with each title in the video content stored in the cloud; and
transmitting information to the first end cache that identifies each title in the video content that is available to be selected for viewing at the first end cache.

37. The method of claim 36, further comprising:
wherein the one or more group attributes define one or more of: one or more property types, one or more languages, one or more cultures, one or more geographic locations, one or more promotions, one or more advertisements, or one or more demographic attributes that each title is associated with; and
wherein determining which video content is to be made available for selection at the first end cache comprising comparing one or more attributes associated with the request to view available video content to the one or more group attributes associated with each title.

38. The method of claim 34, further comprising:
transmitting a control command from the cloud to one of the plurality of end caches, wherein the control command is directed to a device connected to the end cache, wherein the control command controls a function of the device.

39. The method of claim 38, wherein the device connected to the end cache comprises one or a television, a cable or satellite receiver, a light fixture, a HVAC device, or curtains.
